(19) United States
(12) Patent Application Publication
(10) Pub. No.: US 2017/0280292 A1
(43) Pub. Date: Sep. 28, 2017

(54) SYSTEMS AND METHODS FOR GEO-ASSOCIATED MATCHING

(71) Applicant: Anastasia Prapas, San Francisco, CA (US)

(72) Inventor: Anastasia Prapas, San Francisco, CA (US)

(21) Appl. No.: 15/467,026

(22) Filed: Mar. 23, 2017

Related U.S. Application Data
(60) Provisional application No. 62/312,895, filed on Mar. 24, 2016.

(51) Int. Cl. H04W 4/02; G06Q 50/16

(52) U.S. Cl. CPC H04W 4/023; G06Q 50/16; H04W 4/12

(57) ABSTRACT

The present disclosure relates to systems and methods for geo-associated matching. A processor can be configured to access memory and execute the machine readable instructions. The machine readable instructions can cause the processor to receive a request generated by a device, wherein the request comprises location information for the device, extract the location information in response to receiving the request, retrieve agent data associated with a plurality of agents in response to extracting the location information, generate matching instances of the registered agent data based upon the extracted location information, transmit an alert to at least one other device associated with the matching instances, receive an alert response generated by the at least one other device in response to receiving the transmitted alert and establish a communication link between the device and the other device in response to the receiving the alert response.

### CROSS REFERENCED TO RELATED APPLICATION

This application claims the benefit of U.S. Provisional Application No. 62/312,895, filed on Mar. 24, 2016, entitled “SYSTEMS AND METHODS FOR GEO-ASSOCIATED MATCHING”, the contents of which are herein incorporated by reference.

### TECHNICAL FIELD

This disclosure generally relates to systems and methods for geo-associated matching. More specifically, this disclosure relates to systems and methods for geo-associated matching of real estate agents to a party to a real estate transaction.

### BACKGROUND

Many transactions involving the transfer or sale of real estate make use of one or more real estate agents or brokers. The real estate agent can facilitate the transaction by offering guidance to the parties, such as buyers and/or sellers, to the real estate transaction. The selection of a real estate agent by a party to the transaction can be a multiple step process requiring user input during each step of the process.

As an example, a buyer may conduct a key word search for a real estate agent with an internet capable device such as, a computer or a smart phone. As an initial step, the internet capable device can access an internet search engine. The user may need to make multiple inputs to identify the desired keywords and provide input to commence the search. Once the search is complete, the buyer can be provided with multiple search results. Next, the buyer can review the search results and provide input to select one of the results. After the search result is selected, the buyer may be required to navigate through one or more web pages of information in order to access contact information of a real estate agent such as, for example, an email address or a phone number. The buyer can use the contact information to contact (i.e., call or send an email) to the real estate agent.

However, the buyer is not provided with any assurance that the real estate agent is capable of providing a timely response. Often, the buyer may be required to leave a voicemail or wait for a response to an email. The response time can be dependent upon the availability or diligence of the contacted real estate agent. Accordingly, the buyer can frequently be left unsatisfied due to an undesired amount of delay, which can be on the order of days. Furthermore, the voicemail or email may include personal contact information (e.g., phone number and/or email address) of the buyer. In instances where the response is delayed, the unsatisfied buyer may be subjected to undesired communication.

In another example, the buyer may conduct a search for real estate listings with the internet capable device. The search for the real estate listing can involve accessing a listing service over the internet. The buyer can provide input to the listing service to identify search criteria (e.g., price, neighborhood, etc.) and conduct a search for matching listings. The listing service can provide matching listings to the search criteria. Next, the buyer can review the matching listings and provide input to select one of the matching listings. In some instances, the selected listing can provide the contact information of the real estate agent that is listing agent of the seller. Thus, in addition the problems associated with timeliness of response and providing personal contact information, contacting the listing agent can introduce conflict of interest problems associated with dual agency.

Accordingly, a need exists for alternative systems and methods for matching real estate agents and parties of a real estate transaction.

### SUMMARY

In one example a system can include a non-transitory memory to store machine readable instructions and data and a processor to access the memory and execute the machine readable instructions. The machine readable instructions can cause the processor to receive a request generated by a device. The request can include location information for the device. The machine readable instructions can further cause the processor to extract the location information in response to receiving the request, retrieve agent data associated with a plurality of agents in response to extracting the location information, generate matching instances of the registered agent data based upon the extracted location information, transmit an alert to at least one other device associated with the matching instances, receive an alert response generated by the at least one other device in response to receiving the transmitted alert and establish a communication link between the device and the other device in response to the receiving the alert response.

In another example a method can include receiving, at a server, a request generated by a device. The request can include location information for the device. The method can further include extracting, at the server, the location information in response to receiving the request, retrieving, at the server, agent data associated with a plurality of agents in response to extracting the location information, generating, at the server, matching instances of the registered agent data based upon the extracted location information, transmitting, at the server, an alert to at least one other device associated with the matching instances, receiving, at the server, an alert response generated by the at least one other device in response to receiving the transmitted alert and establishing, at the server, a communication link between the device and the other device in response to the receiving the alert response.

### BRIEF DESCRIPTION OF THE DRAWINGS

FIG. 1 depicts an example of a system for geo-associated matching.

FIG. 2 depicts an example of a geo-sensing device.

FIG. 3 depicts an example of a method for requesting a communication link.

FIG. 4 depicts an example of a geo-sensing device.

FIGS. 5 and 6 depict an example of a method for selectively establishing a communication link.

FIG. 7 depicts an example of a method for responding to a broadcast alert.

FIG. 8 depicts an example of a subscriber device.

### DETAILED DESCRIPTION

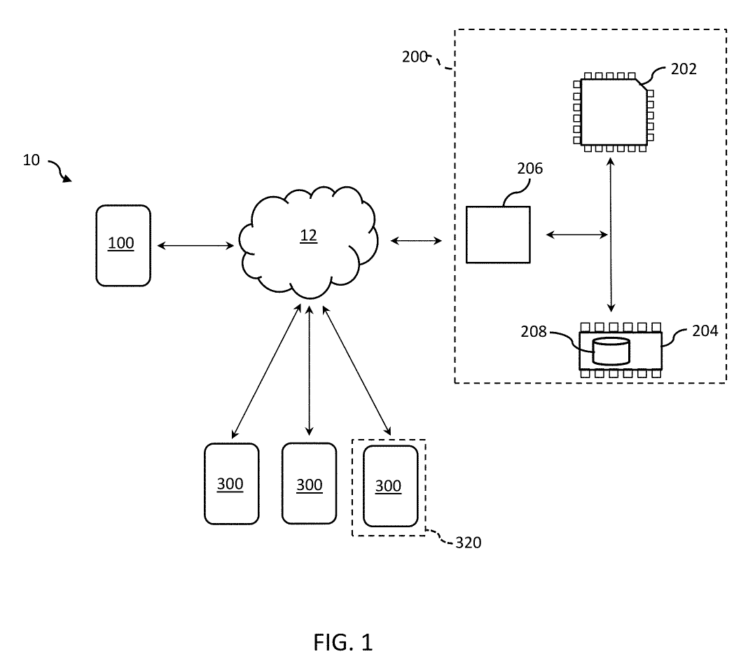

FIG. 1 illustrates an example of a system 100 for geo-associated matching. The system 10 can be used to implement methods described herein. The system 10 can include a geo-sensing device 100, a communication link server 200, and a plurality of subscriber devices 300. The communication link server 200 can be configured to selectively establish a communication link between the geo-sensing device 100 and one of the subscriber devices of the plurality of subscriber devices 300.

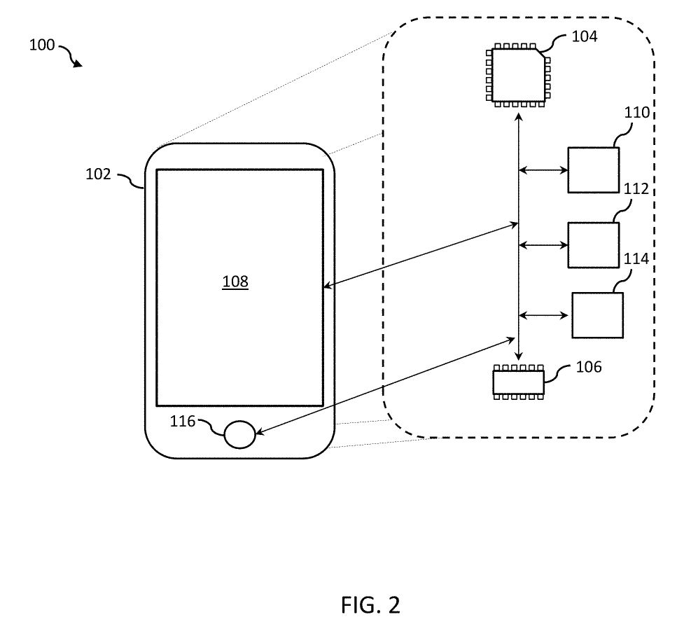

FIG. 2 illustrates an example of a geo-sensing device 100, such as illustrated in FIG. 1. The geo-sensing device 100 can include a smart phone 102. It is noted that the description provided herein regarding the smart phone 102 is for clarity, and is not intended to limit the description to any specific machine. Various devices, such as the smart phone 102, can be employed without departing from the scope of the examples described herein such as, for instance, a mobile phone, a tablet, a laptop computer, desktop computer, or a specialized machine having communication capability. The smart phone 102 can include one or more processors 104 that can be configured to execute machine readable instructions to perform functions according to the methods described herein. As used herein, the term “processor” can include any device that can be capable of executing machine readable instructions. Accordingly, each processor 104 can be a controller, an integrated circuit, a microchip, or any other device capable of implementing logic. In one example, the one or more processors 104 can include a touch screen controller, a baseband controller, graphics processor, application processor, image processor, or the like.

The smart phone 102 can include memory 106 that can be communicatively coupled to the one or more processors 104 (generally depicted as double arrowed lines in FIG. 2). The memory 106 described herein can be Random Access Memory (RAM), Read-only memory (ROM), a flash memory, a hard drive, or any device that can store machine readable instructions. Accordingly, the smart phone 102 can be configured to execute a mobile operating system by executing the machine readable instructions. The mobile operating system can include one of, but not limited to, Android, iOS, Blackberry OS, Windows Phone, Symbian, and the like.

Additionally, it is noted that the functions, modules, and processes described herein can be provided as machine readable instructions stored on the memory 106 that can be executed by the one or more processors 104. The machine readable instructions can be provided in any programming language of any generation (e.g., 1GL, 2GL, 3GL, 4GL, or 5GL) or any programming paradigm such as, but not limited to, machine language that may be directly executed by the processor, or assembly language, object-oriented programming (OOP) languages, scripting languages, microcode, procedural programming languages (e.g., C, Go, Fortran, or the like), etc., that may be compiled or assembled into machine readable instructions and stored on a machine readable medium. Alternatively, the functions, modules, and processes described herein can be written in a hardware description language (HDL) or provided as software defined hardware (SDH), such as logic implemented via either a field-programmable gate array (FPGA) configuration or an application-specific integrated circuit (ASIC). Accordingly, the functions, modules, and processes described herein can be implemented in any conventional computer programming language, as pre-programmed hardware elements, or as a combination of hardware and software components.

The smart phone 102 can include a display 108 that can be communicatively coupled to the one or more processors 104 for providing optical signals and conveying visual feedback to users of the smart phone 102. In one example, the display 108 can be configured to selectively illuminate a plurality of pixels to provide the optical signals. Accordingly, the display 108 can include light emitting diodes (LEDS) or organic LEDS (OLEDS) (, a liquid crystal display (LCD), a liquid crystal on silicon (LCOS), or the like. Additionally, the display 108 can be configured to operate as a touch screen for accepting input via visual controls. Accordingly, the display 108 can include a touch detector such as, for example, a resistive sensor, capacitive sensor, or the like. It is noted that the term “signal,” as used herein, can include a waveform (e.g., electrical, optical, magnetic, or electromagnetic), such as DC, AC, sinusoidal-wave, triangular-wave, square-wave, and the like, capable of traveling through a medium.

The smart phone 102 can further include a network interface hardware 110 that can be communicatively coupled to the one or more processors 104 for communicatively coupling the smart phone 102 to another device via a network such as, for example, a wide area network, a local area network, personal area network, a global positioning system and combinations thereof. Accordingly, the network interface hardware 110 can be configured to communicate, e.g., send and/or receive data signals via any wired or wireless communication protocol. For example, the network interface hardware 110 can include an antenna, a modem, LAN port, wireless fidelity (Wi-Fi) card, WiMax card, near-field communication hardware, satellite communication hardware, or the like. Accordingly, the smart phone 102 can be communicatively coupled to a network via wires, via a wide area network, via a local area network, via a personal area network, via a satellite network, or the like. Suitable local area networks can include wired Ethernet and/or wireless technologies such as, for example, Wi-Fi. Suitable personal area networks can include wireless technologies such as, for example, IrDA, BLUETOOTH, Wireless USB, Z-WAVE, ZIGBEE, or the like. Alternatively or additionally, suitable personal area networks can include wired computer buses such as, for example, USB and FIREWIRE. Thus, any components of the smart phone 102 can utilize one or more network components to communicate signals via the Internet or World Wide Web.

The smart phone 102 can further include radio frequency (RF) hardware 112. The RF hardware can be communicatively coupled to the one or more processors 104 and can communicatively coupling the smart phone 102 with a cellular network. Suitable cellular networks can include, but are not limited to, technologies such as Long-Term Evolution (LTE), Worldwide Interoperability for Microwave Access (WiMAX), Universal Mobile Telecommunication Service (UMTS), Code Division Multiple Access (CDMA), and Global System for Mobile Communications (GSM). In some examples, the RF hardware 112 can include components suitable for communicating voice information and data signals such as, for instance, modems, attenuators, antennas, antenna switches, amplifiers, receivers, transceivers, or combinations thereof. Accordingly, the smart phone 102 described herein can utilize a cellular network to communicate signals over the Internet or World Wide Web.

The smart phone 102 can further include a Global Positioning System (GPS) receiver 114 that can be communicatively coupled to the one or more processors 104. The GPS receiver 114 can be configured to provide signals representative of the location of the geo-sensing device 100. The GPS receiver 114 can be configured to receive signals encoded with location data, time data or both from a plurality of GPS satellites.

The smart phone 102 can further include one or more input components 116 for sensing user input and encoding the user input into a signal representative of the user input. The input component 116 can include at least one of a button, a knob, a switch, a resistive sensor, capacitive sensor, a camera, a microphone, a keyboard. Alternatively or additionally, the display 108 can be configured to receive user input and operate as the input component 116. The smart phone 102 can further include additional components such as, for example, a speakers, a gyroscope, accessory lights (e.g., LED), an accelerometer, an optical sensor, or the like.

In one example, the communication link server 200 can be configured to host an enterprise application to selectively establish communication links. The communication link server 200 can include one or more processors 202 that can be communicatively coupled to a memory 204 of the communication link server 200. The one or more processors 202 can be communicatively coupled to a network interface hardware 206 of the communication link server 200. It is noted that, while the communication link server 200 is schematically depicted in FIG. 1 as being a single machine, each of the one or more processors 202, the memory 204, and the network interface hardware 206 can be distributed amongst a plurality of machines that are communicatively coupled to one another. The one or more processors 202 can be configured to execute web server software provided as machine readable instructions that can be, for example, stored in the memory 204. The web server software can include one of, but not limited to, Apache Hypertext Transfer Protocol (HTTP) Server, Internet Information Services, Nginx, Google Web Server, or the like. Accordingly, the communication link server 200 can employ a server operating system such as, for example, Unix, Linux, Berkeley Software Distribution (BSD), Microsoft Windows, or the like.

The communication link server 200 can be configured to establish the communication links over the Internet 12. The communications links can be provided using internet telephony. The communication links can include, but not limited to, voice over IP (VoIP) phone calls, Short Message Service (SMS), voice-messaging, and the like. Accordingly, the communication link server 200 can be configured to establish the communication links using internet telephony protocols such as, for example, H.323, Media Gateway Control Protocol (MGCP), Session Initiation Protocol (SIP), H.248 (Megaco), Real-time Transport Protocol (RTP), and the like.

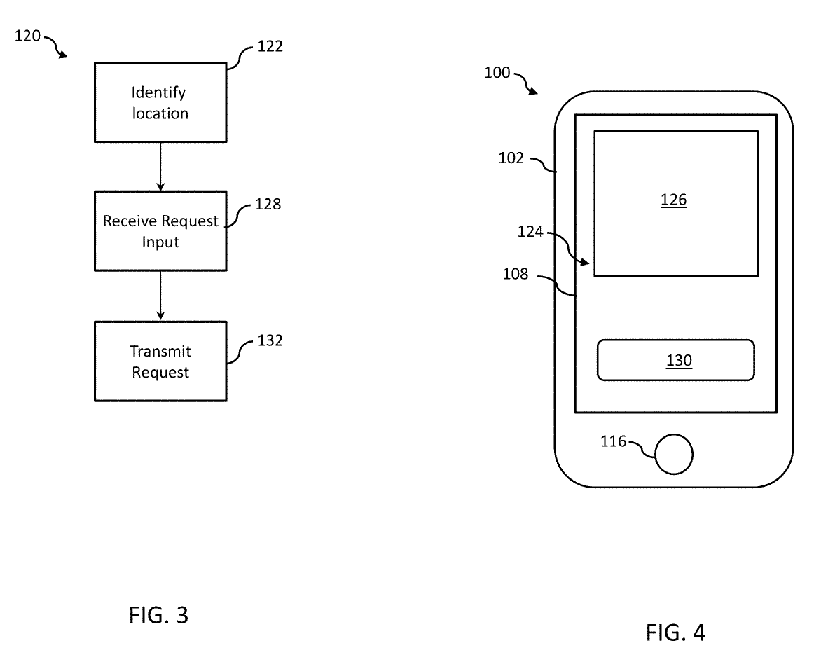

Referring collectively to FIGS. 2, 3, and 4, the one or more processors 104 of the geo-sensing device 100 can be configured to execute machine readable instructions to automatically perform a method 120 for requesting a communication link. The method 120 can include, at step 122, identifying the location of the geo-sensing device 100. In one example, the GPS receiver 114 can be configured to provide a signal representative of the current determined location for the geo-sensing device 100. In an alternative example, a last known determined location for the geo-sensing device 100 can be used as a substitute for the current determined location. Thus, at step 122, the last known determined location for the geo-sensing device 100 can be used.

In one example, a user interface 124 can be provided upon the display 108. The user interface 124 can include a determined location object 126 that can provide visual information corresponding to the current determined location. For example, the detected location object 126 can provide text indicative of the current determined location, a map indicative of the current determined location, or a combination thereof.

The method 120 can further include, at step 128, receiving a user input representative of a request to establish a communication link with a registered agent. In some examples, the user interface 124 can include a request object 130 configured to receive user input and generate a signal responsive to the user input. For example, the request object 130 can occupy a portion of the display 108 and provide a signal indicative of selection the request object 130 in response to tactile input provided to the display 108. Alternatively, at step 122, an input component 116 can be used to receive user input such as, for example, tactile input, audible input, optical input, or the like. Accordingly, at step 122, a singular user input can be received and transformed into the signal indicative of desire to link with a registered agent.

Referring collectively to FIGS. 1, 2, and 3, the method 120 can further include, at step 132, transmitting a request to the communication link server 200 to establish a communication link with a registered agent. For example, responsive to the signal indicative of desire to link with a registered agent, the geo-sensing device 100 can be configured to transmit the request to the communication link server 200. The request can be encoded with information representative of the of the current determined location of the geo-sensing device 100. Additionally, the request can be encoded with personal contact information such as, for example, a telephone number associated with the smart phone 102, an email address, or the like. In some examples, the request can be transmitted via the Internet 12. For example, the network communication hardware 110 or the RF hardware 112 can communicate the request to the network interface hardware 206 of the communication link server 200 over the internet 12. Alternatively or additionally, the RF hardware 112 can communicate the request to the network interface hardware 206 of the communication link server 200 using internet telephony protocols.

Referring collectively to FIGS. 1, 5, and 6, the one or more processors 202 of the communication link server 200 can execute machine readable instructions stored in the memory 204 to automatically perform a method 210. The method 210 can include, at step 212, receiving the request from the geo-sensing device 100. In one example, at step 212, the communication link server 200 can be configured to persistently monitor the network interface hardware 206 for the request from the geo-sensing device 100. The communication link server 200 can be configured to automatically extract data corresponding to the current determine location and/or the personal contact information from the request in response receiving the request.

The method 210 can further include, at step 214, generating a match to the request. At step 214, the one or more processors 202 can access a data store 208 of registered agents being stored in the memory 204. Alternatively, the data store 208 can be stored on another device or server and the one or more processors 202 can be configured to retrieve the data store 208 via the internet 12 from the other device or the server. The data store 208 can include registered agent data that can be associated with one or more agent parameters. It is noted that the phrase “data store,” as used herein, can refer to associated data instances that are capable of being accessed or retrieved using information provided to one of the associated data instances.

In some examples, the registered agent data can be associated with a geographic parameter. The geographic parameter can identify one or more geographic regions 216. For example, the geographic regions 216 can correspond to any quantifiable locality such as, for example, a neighborhood, a city, a state or the like. In some examples, the geographic parameter can be customized to associate the registered agent data with one or more geographic regions 216 based upon a desired criteria. For example, the geographic parameter can be indicative of the registered agents familiarity with a region, number of sales in the region, or the like.

Referring still to FIGS. 1, 5, and 6, at step 214, the determined location 218 for the geo-sensing device 100 can be compared to the geographic regions 216 of the registered agent data to identify matching regions 220. In some examples, a bounding region 222 can be registered to the determined location 218 and can define a region that is coincident surrounds the determine location 218. In one example, the bounding region 222 can be a circular region centered upon the extracted location. The matching regions 220 can correspond to the geographic regions 216 that are coincident with the bounding region 222. Optionally, a size and shape of the bounding region 222 can be modified based upon the density of agents associated with the matching regions 220. For example, if the density of registered agents associated with the matching regions 220 is below a threshold, the size of the bounding region 222 can be increased (e.g., larger radius for a circular region) and step 214 can be repeated. Likewise, if the density of registered agents associated with the matching regions 220 is above a threshold, the size of the bounding region 222 can be decreased (e.g., smaller radius for a circular region) and step 214 can be repeated. Once the matching regions 220 are identified, each instance of the registered agent data with a geographic parameter that can correspond to the matching regions can be identified as a matching instance of the registered agent data.

The method 210 can further include, at step 224, broadcasting an alert to each registered agent of the matching instances of the registered agent data. At step 224, the one or more processors 202 can access an contact information parameter of the matching instances of the registered agent data. In some example, the contact information parameter can identify a telephone number or any other unique identifier for a corresponding registered agent. Accordingly, the communication link server 200 can broadcast the alert as a telephone call, an SMS, or any other internet-based communication. The communication link server 200 can broadcast the alert to each subscriber device 300 associated with a registered agent.

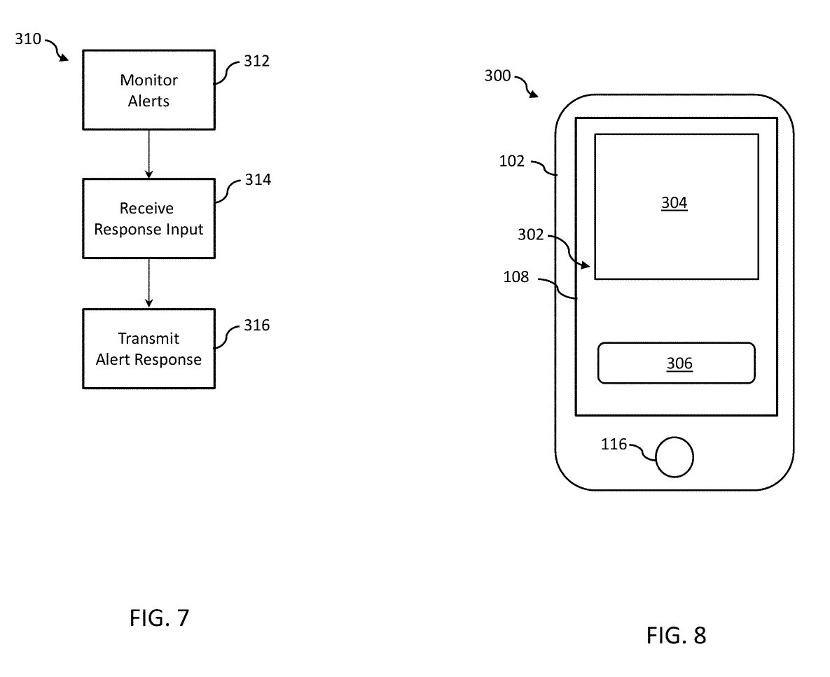

Referring collectively to FIGS. 1, 7, and 8, the contact information parameter of each instance of the registered agent data can be associated with the subscriber device 300. In some examples, the subscriber device 102 can include a smart phone similar to the smart phone 102, as described herein. Accordingly, the one or more processors 104 of each subscriber device 300 can be configured to execute machine readable instructions to automatically perform a method 310 for responding to a broadcast alert. The method 310 can include, at step 312, monitoring for alerts generated by the communication link server 200. At step 312, the subscriber devices 300 can be configured to periodically and/or continuously monitor the network interface hardware 110, the RF hardware 112, or both for an alert generated by the communication link server 200. The subscriber device 300 can be configured to provide an indication of the received alert in response to receiving the alert. For example, a user interface 302 of the subscriber device 300 can be configured to provide upon the display 108 the indication of the received alert. The user interface 302 can include an alert indication object 304 that can provide visual information corresponding to the received alert. Alternatively or additionally, the subscriber device 300 can provide an audible notification, tactile notification (e.g., vibration), or the like.

The method 310 can further include, at step 314, receiving user input, for example, at the subscriber device 300, indicative of a response to the alert. In some example, the user interface 306 can include a response object 306 that can configured to receive user input and generate a signal indicative of acceptance of the alert. In some examples, the response object 306 can be configured to receive input indicative of a desire to accept a phone call. Alternatively or additionally, the response object 306 can be configured to receive input for populating an SMS message.

The method 310 can further include, at step 316, transmitting an alert response indicative of a desire to establish a communication link with the user. For example, responsive to the signal indicative of acceptance of the alert, the subscriber device 300 can be configured to transmit the alert response to the communication link server 200. The alert response can include any internet based communication. In some examples, the alert response can include accepting an incoming telephone call. Alternatively or additionally, the alert response can be an SMS message.

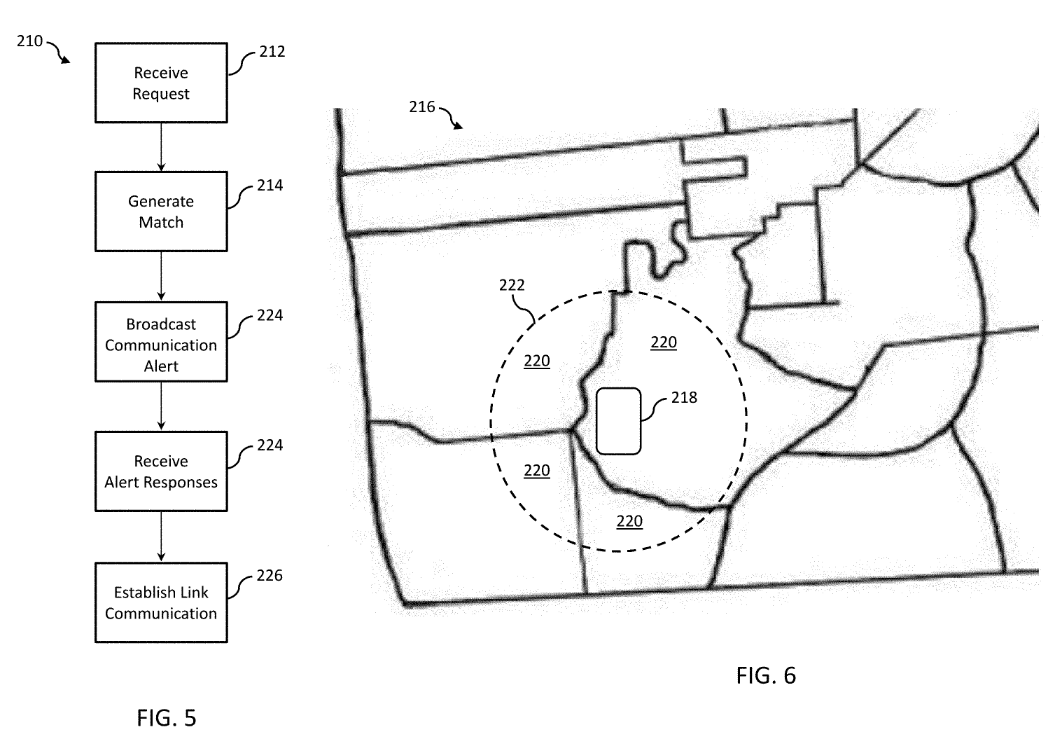

Referring again to FIGS. 1 and 5, the method 210 can further include, at step 224, receiving an alert response(s) from the subscriber devices 300. At step 224, the communication link server 200 can periodically or continuously monitor the network interface hardware 206 for the alert response(s). In some examples, the communication link server 200 can be configured to identify the order of received alert responses.

The method 210 can further include, at step 226, selectively establishing a communication link between the geo-sensing device 100 and one of the subscriber devices 300. In some examples, the communication link server 200 can identify a selected subscriber 320 based upon the order of the received alert responses. For example, the selected subscriber 320 can be the subscriber device 300 that transmitted the alert response that was first received by the communication link server 200.

In some examples, the communication link server 200 can be configured to hand off the received alert response to the geo-sensing device 100. For example, when the alert response includes a telephone call, the communication link server 200 can route the telephone call to the geo-sensing device 100 based on at least the personal contact information extracted from the request. In examples where the alert response includes an SMS message, the communication link server 200 can be configured to route the SMS message to the geo-sensing device 100 based on at least the personal contact information extracted from the request. Accordingly, the system 10 can be configured to establish a live communication link between the selected subscriber device 320 and the geo-sensing device 100 based upon a single received input.

It should now be understood that the examples described herein can be used to selectively establish a communication link between a party to a real estate transaction and a real estate agent. The system can use location based information to match a party to a real estate agent, while reducing the amount of user input and data processing steps needed to make the match. Accordingly, the computation costs on the user's device can be reduced.

Moreover, the examples described herein can be employed to reduce time between the request for information and a first live interaction between the party and the real estate agent. Indeed, the party can receive a prompt response that feels substantially instantaneous. Additionally, the personal contact information of the user can be protected by only sharing the information with real estate agents that are actively participating in communicating with the party. The prompt response can improve the user experience and increase the likelihood that the party will consummate the real estate transaction. Thus, the examples provided herein can be used to generate more useful leads for real estate agents.

It is noted that the term “substantially” may be used herein to represent the inherent degree of uncertainty that may be attributed to any quantitative comparison, value, measurement, or other representation. The term can also be used herein to represent the degree by which a quantitative representation may vary from a stated reference without resulting in a change in the basic function of the subject matter at issue.

What have been described above are examples. It is, of course, not possible to describe every conceivable combination of components or methods, but one of ordinary skill in the art will recognize that many further combinations and permutations are possible. Accordingly, the present disclosure is intended to embrace all such alterations, modifications, and variations that fall within the scope of this application, including the appended claims.

What is claimed is:

1. A system comprising:
a non-transitory memory to store machine readable instructions and data; and
a processor to access the memory and execute the machine readable instructions, the machine readable instructions causing the processor to:
receive a request generated by a device, wherein the request comprises location information for the device;
extract the location information in response to receiving the request;
retrieve agent data associated with a plurality of agents in response to extracting the location information;
generate matching instances of the registered agent data based upon the extracted location information;
transmit an alert to at least one other device associated with the matching instances;
receive an alert response generated by the at least one other device in response to receiving the transmitted alert; and
establish a communication link between the device and the other device in response to the receiving the alert response.

2. The system of claim 2,
wherein the agent data comprises one or more agent parameters associated with each agent; and
wherein the one or more agent parameters comprise a location parameter associated with at least one geographical region.

3. The system of claim 2, wherein the at least one geographical region comprises one of a predetermined zone, a county, a neighborhood, a city, a state, a country and a continent.

4. The system of claim 2, wherein the location parameter is determined based on one of a value representing an agents familiarity with the at least one geographical region and a number of sales in the at least one geographical region within one of previous a month, a plurality of previous months and a plurality of previous years.

5. The system of claim 2,
wherein generating matching instances of the registered agent data comprises:
comparing the at least one geographical region relative to the location information for the device; and
identifying at least one agent associated with the at least one geographical region based on a result of the comparison indicating that the device is one of located within the at least one geographical region and located within a given distance of the at least one geographical region.

6. The system of claim 5, wherein transmitting the alert to at least one other device associated with the matching instances comprises transmitting the alert to the at least one other device associated with the at least one geographical region.

7. The system of claim 2, wherein the machine readable instructions further cause the processor to register the location information for the device with a bounding region have a defined boundary.

8. The system of claim 7, wherein the bounding region is one of a given shape region, circular region, a square region and a polygonal region.

9. The system of claim 8, wherein a size of the bounding region is a function of a number of agents associated with the geographical region.

10. The system of claim 7,
wherein generating matching instances of the registered agent data comprises:
comparing the at least one geographical region relative to the bound region; and
identifying at least one overlapping region based on a result of the comparison.

11. The system of claim 10, wherein transmitting the alert to at least one other device associated with the matching instances comprises transmitting the alert to the at least one other device based on the at least one geographical region associated with the at least one overlapping region.

12. The system of claim 1, wherein the location information is one of current determined location information or previously determined location information for the device.

13. The system of claim 1, wherein transmitting the alert comprises one of a telephone call, a short message service (SMS) and an email.

14. The system of claim 1, wherein the communication link comprises one of a voice over IP (VoIP) phone call, a short message service (SMS) and a voice-message.

15. The system of claim 1, wherein the device and the other device comprises one of a mobile phone, a tablet, a laptop computer and a desktop computer.

16. A method comprising:
receiving, at a server, a request generated by a device, wherein the request comprises location information for the device;
extracting, at the server, the location information in response to receiving the request;
retrieving, at the server, agent data associated with a plurality of agents in response to extracting the location information;
generating, at the server, matching instances of the registered agent data based upon the extracted location information;
transmitting, at the server, an alert to at least one other device associated with the matching instances;
receiving, at the server, an alert response generated by the at least one other device in response to receiving the broadcasted alert; and
establishing, at the server, a communication link between the device and the other device in response to the receiving the alert response.

17. The method of claim 16, wherein the location information is one of current determined location information or previously determined location information for the device.

18. The method of claim 16,
wherein the agent data comprises one or more agent parameters associated with each agent; and
wherein the one or more agent parameters comprises a location parameter associated with at least one geographical region.

19. The method of claim 18,
wherein generating matching instances of the registered agent data comprises:
comparing the at least one geographical region relative to the bound region; and
identifying at least one overlapping region based on a result of the comparison; and
wherein transmitting the alert to at least one other device associated with the matching instances comprises:
transmitting the alert to the at least one other device based on the at least one geographical region associated with the at least one overlapping region.

20. The method of claim 18,
further comprising register the location information for the device with a bounding region have a defined boundary;
wherein generating matching instances of the registered agent data comprises:
comparing the at least one geographical region relative to the bound region; and
identifying at least one overlapping region based on a result of the comparison; and
wherein transmitting the alert to at least one other device associated with the matching instances comprises:
transmitting the alert to the at least one other device based on the at least one geographical region associated with the at least one overlapping region.
